(19) United States
(12) Patent Application Publication
(10) Pub. No.: US 2021/0390312 A1
(43) Pub. Date: Dec. 16, 2021

(54) Participant identification in imagery

(71) Applicant: Photo Butler Inc., Easton, MA (US)

(72) Inventors: Gerald Hewes, Lexington, MA (US); Craig Carlson, Wakefield, MA (US); Zhikang Ding, Malden, MA (US); Joseph C. Cuccinelli, JR., Needham, MA (US); David Benaim, Newton Centre, MA (US); Joe Regan, Boston, MA (US); Andrew P. Goldfarb, Brookline, MA (US)

(21) Appl. No.: 17/295,024

(22) PCT Filed: Dec. 6, 2019
(86) PCT No.: PCT/US2019/065017

§ 371 Date: Jun. 30, 2021

Related U.S. Application Data
(60) Provisional application No. 62/777,062, filed on Dec. 7, 2018.

(51) Int. Cl. G06K 9/00; G06K 19/06

(52) U.S. Cl. CPC G06K 9/00724; G06K 19/06028; G06K 9/00362; G06K 9/00288

(57) ABSTRACT

Methods and systems for identifying at least one participant in imagery related to an event. The methods described herein may involve receiving imagery related to an event and executing at least one of an indicia identification procedure to identify at least one visual indicia in the imagery and a facial identification procedure to identify at least one face in the imagery. The methods described herein may then identify a person in the imagery based on at least one of the execution of the indicia identification procedure and the facial identification procedure.

### CROSS-REFERENCE TO RELATED APPLICATIONS

The present application claims the benefit of co-pending U.S. provisional application No. 62/777,062, filed on Dec. 7, 2018, the entire disclosure of which is incorporated by reference as if set forth in its entirety herein.

### TECHNICAL FIELD

The present application generally relates to systems and methods for analyzing imagery and, more particularly but not exclusively, to systems and methods for identifying event participants in imagery.

### BACKGROUND

People participating in events such as races, competitions or the like are interested in possessing or at least viewing imagery of themselves during such events. Similarly, event organizers are interested in offering photography and/or video services related to their event. The photographs or videos are often taken by professional photographers or crowd sourced from others at the event location.

Techniques for identifying people in this imagery generally rely on bibs or some other type of identifier worn on the participants' back, chest, arm(s), wrist(s), head, equipment, or the like. Other existing techniques may additionally or alternatively rely on race timing information. However, both classes of solutions have their limitations.

For example, using bibs alone is not reliable as bibs may be lost or not worn by participants, numbers on a participant's bib might not be visible, or some numbers on the bib may not be recognizable or may otherwise be obscured. Similarly, time-based techniques usually return imagery of other participants taken at roughly the same time because multiple participants may be at the same spot at the same time. These techniques therefore require users to filter through images of other participants.

A need exists, therefore, for systems and methods for identifying event participants in imagery that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method for identifying at least one participant in imagery related to an event. The method includes receiving imagery related to the event; executing, using a processor executing instructions stored on memory, at least one of an indicia identification procedure to identify at least one visual indicia in the imagery and a facial identification procedure to identify at least one face in the imagery; and identifying, using the processor, a person in the imagery based on at least one of the execution of the indicia identification procedure and the facial identification procedure.

In some embodiments, the method further includes receiving time data from an imagery gathering device regarding when imagery was gathered, receiving time data regarding when an indicia was recognized, and calibrating the processor based on a difference between the time data from an imagery gathering device and the time data regarding when an indicia was recognized.

In some embodiments, the method further includes executing a location procedure to determine where the received imagery was gathered, wherein identifying the person in the imagery further comprises utilizing where the received imagery was gathered. In some embodiments, the location procedure analyzes at least one of location data associated with an imagery gathering device and location data associated with the person in the imagery.

In some embodiments, the method further includes executing, using the processor, a clothing recognition procedure to identify clothing in the imagery, wherein identifying the person in the imagery further comprises utilizing the identified clothing.

In some embodiments, the method further includes receiving feedback regarding the person identified in the imagery, and updating at least one of the indicia identification procedure and the facial identification procedure based on the received feedback.

In some embodiments, the visual indicia include at least a portion of an identifier worn by a person in the imagery.

In some embodiments, the method further includes receiving time data regarding when the imagery was gathered, wherein identifying the person in the imagery further comprises matching the received time data related to the imagery with at least one of time data regarding the participant.

In some embodiments, the method further includes assigning a confidence score to an imagery portion based on at least one of the execution of the indicia identification procedure and the facial recognition procedure, and determining whether the assigned confidence score exceeds a threshold, wherein identifying the person in the imagery comprises identifying the person based on the assigned confidence score of the imagery portion exceeding the threshold.

In some embodiments, the method further includes indexing a plurality of imagery portions of the imagery that include an identified person for later retrieval.

In some embodiments, the method further includes receiving a baseline imagery of a first participant, receiving a first identifier, and associating the first identifier with the first participant based on the baseline imagery of the first participant.

According to another aspect, embodiments relate to a system for identifying at least one participant in imagery related to an event. The system includes an interface for receiving imagery related to an event, and a processor executing instructions stored on memory and configured to execute at least one of an indicia identification procedure to identify at least one visual indicia in the imagery and a facial identification procedure to identify a face in the imagery; and identify a person in the imagery based on the execution of at least one of the indicia identification procedure and the facial identification procedure.

In some embodiments, the processor is further configured to execute a location procedure to determine where the received imagery was gathered, and identify the person in the imagery utilizing where the imagery was gathered. In some embodiments, the location procedure analyzes at least one of location data associated with an imagery gathering device and location data associated with the person in the imagery.

In some embodiments, the processor is further configured to execute a clothing recognition procedure to identify clothing in the imagery, and identify the person in the imagery utilizing the identified clothing.

In some embodiments, the interface is further configured to receive feedback regarding the person identified in the imagery, and the processor is further configured to update at least one of the indicia identification procedure and the facial identification procedure based on the received feedback.

In some embodiments, the visual indicia includes at least a portion of an identifier worn by a person in the imagery.

In some embodiments, the processor is further configured to receive time data related to the imagery, and identify the person utilizing the received time data related to the imagery.

In some embodiments, the processor is further configured to assign a confidence score to an imagery portion based on at least one of the execution of the indicia identification procedure and the facial recognition procedure, determine whether the assigned confidence score exceeds a threshold, and identify the person in the imagery portion based on the assigned confidence score exceeding the threshold.

In some embodiments, the processor is further configured to index a plurality of imagery portions of the imagery that include an identified person for later retrieval.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a system for identifying at least one participant in imagery related to an event in accordance with one embodiment; and

FIG. 2 illustrates a method for identifying at least one participant in imagery related to an event in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments described herein provide systems and methods for identifying event participants in imagery. Specifically, the embodiments described herein may rely on any one or more of visual indicias or markers such as bibs, identified faces, recognized clothing, location data, and time data. The systems and methods described herein may therefore achieve a more precise and higher-confidence identification of participants in gathered imagery using state-of-the-art recognition software than capable with existing techniques.

In some embodiments, the event of interest may be a race such as a marathon, half-marathon, a ten kilometer race (“10k”), a five kilometer race (“5k”), or the like. Although the present application largely discusses race events in which participants run, walk, or jog, the embodiments described may be used in conjunction with other types of sporting events or races, such as triathlons, decathlons, biking races, or the like.

In operation, a user such as an event organizer may generate or otherwise receive a list of participants in the race. The organizer may then assign each participant some identifier such as a numeric identifier, an alphabetic identifier, an alphanumeric identifier, a symbolic identifier, or the like (for simplicity, “identifier”).

Before the race, the event organizers may issue bibs or some other label to the participants for them to wear. More specifically, each participant may be issued a bib with their assigned identifier. The participants may then be instructed to wear their issued bibs to, at the very least, assure event organizers that they are registered to participate in the event.

During the race, imagery may be gathered of the participants at various locations throughout the race path. In the context of the present application, the term “imagery” may refer to photographs, videos (e.g., frames of which may be analyzed), mini clips, animated photographs, video clips, motion photos, or the like. Imagery may be gathered by participants' family or friends, by professional videographers, by photographers hired by the event organizers, by stationary imagery gathering devices, or some combination thereof.

The gathered imagery may be communicated to one or more processors for analysis. The processor(s) may then analyze the received imagery using one or more of a variety of techniques to identify participants in imagery or to otherwise identify imagery that includes a certain participant.

Accordingly, the methods and systems described herein provide novel ways to analyze imagery of an event to identify the most relevant imagery. Imagery may then be indexed so that imagery including a certain participant may be stored and subsequently retrieved for viewing.

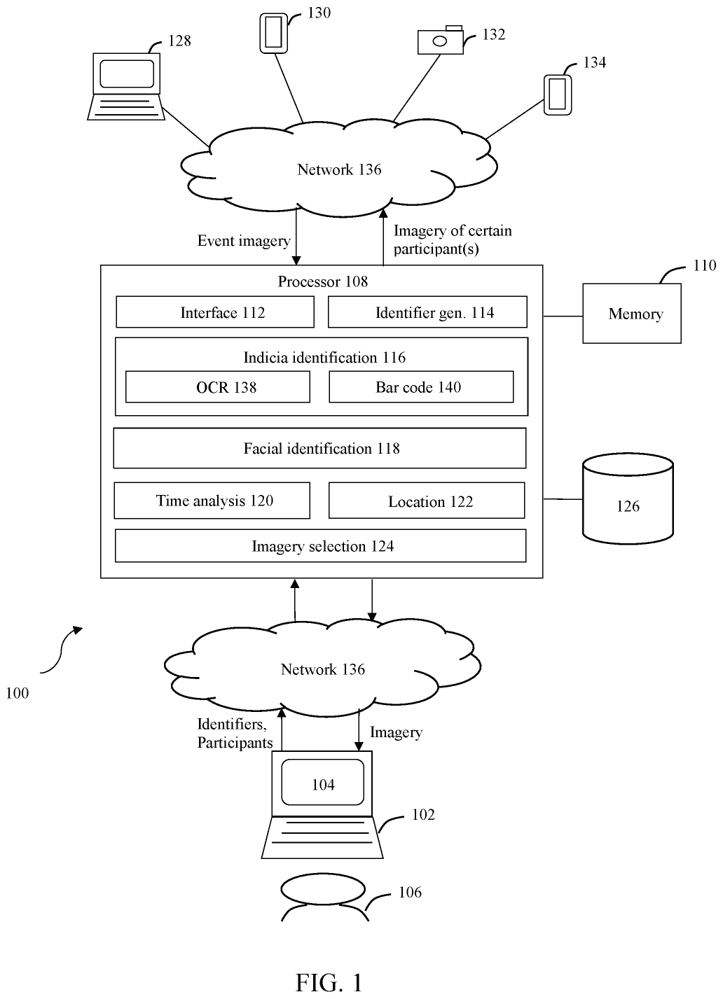

FIG. 1 illustrates a system 100 for identifying at least one participant in imagery related to an event in accordance with one embodiment. The system 100 may include a user device 102 executing a user interface 104 for presentation to a user 106. The user 106 may be an event manager or otherwise someone tasked with reviewing event imagery, an event participant, a friend or family member of a participant, or anyone else interested in gathering or reviewing imagery of an event participant.

The user device 102 may be any hardware device capable of executing the user interface 104. The user device 102 may be configured as a laptop, PC, tablet, mobile device, television, or the like. The exact configuration of the user device 102 may vary as long as it can execute and present the user interface 104 to the user 106. The user interface 104 may allow the user 106 to, for example, associate identifiers with participants, view imagery regarding an event, select participants of interest (i.e., participants of whom to select imagery), view selected imagery that includes participants of interest, provide feedback, or the like.

The user device 102 may be in operable communication with one or more processors 108 over one or more networks 136. The processor(s) 108 may be any one or more of hardware devices capable of executing instructions stored on memory 110 to accomplish the objectives of the various embodiments described herein. The processor(s) 108 may be implemented as software executing on a microprocessor, a field programmable gate array (FPGA), an application-specific integrated circuit (ASIC), or another similar device whether available now or invented hereafter.

In some embodiments, the system 100 may rely on web- or application-based interfaces that run across the internet. For example, the user device 102 may render a web user interface. However, in other cases, the system 100 may rely on application version that run software on a user's mobile device or other type of device.

In some embodiments, such as those relying on one or more ASICs, the functionality described as being provided in part via software may instead be configured into the design of the ASICs and, as such, the associated software may be omitted. The processor(s) 108 may be configured as part of the user device 102 on which the user interface 104 executes, such as a laptop, or may be located on a different computing device, perhaps at some remote location or configured as a cloud-based solution.

Although FIG. 1 only illustrates a single processor 108, there may be several processing devices in operation. These may include a processor executing server software and processor(s) running on the user device 106 (or other devices associated with end users).

The memory 110 may be L1, L2, L3 cache or RAM memory configurations. The memory 110 may include non-volatile memory such as flash memory, EPROM, EEPROM, ROM, and PROM, or volatile memory such as static or dynamic RAM, as discussed above. The exact configuration/type of memory 110 may of course vary as long as instructions for identifying event participants in imagery can be executed by the processor 108 to accomplish the features of various embodiments described herein.

The processor 108 may execute instructions stored on memory 110 to provide various modules to accomplish the objectives of the embodiments described herein. Specifically, the processor 108 may execute or otherwise include an interface 112, an identifier generation module 114, an indicia identification module 116, a facial identification module 118, a time analysis module 120, a location analysis module 122, and an imagery selection module 124.

As discussed previously, a user 106 may first obtain or otherwise receive a list of participants in an event. This list may be stored in or otherwise received from one or more databases 126.

The user 106 may then assign an identifier to each participant. For example, the user 106 may assign identifier “0001” to the first listed participant, “0002” to the second listed participant, and so on.

Alternatively, the identifier generation module 114 may then generate a plurality of random identifiers that are each assigned to a different participant. Accordingly, each participant may be associated with some unique identifier.

Prior to the race or event starting, each participant may receive a bib with their associated identifier thereon. These bibs may be worn over the participant's clothing, and may present the identifier on the front side of the participant and/or the back side of the participant. In other words, a spectator can see a participant's identifier whether they are in front of or behind the participant. Similarly, imagery of a participant may also include the participant's identifier.

In some embodiments, the processor 108 may also receive baseline imagery of one or more of the participants. For example, a participant may gather imagery of themselves (e.g., by taking a “selfie”) before the race and may communicate their gathered imagery to the processor 108 for storage in the database(s) 126. Or, the user 106 or some other event personnel may gather the baseline imagery of the participant, as well as their clothing, bib, or the like, prior to the event. In the context of the present application, the term “clothing” can refer to anything worn by or otherwise attached to or on a participant such that it would appear to be associated with the participant in imagery. This clothing may include, but is not limited to bracelets, watches or other devices, hats, caps, shoes, backpacks, flags, banners, or the like.

The processor 108 may then anchor or otherwise associate the baseline imagery with the participant's name and their identifier. For example, for one or more participants, this data may be stored in the database(s) 126 in the form of:

Accordingly, the baseline imagery may help identify participants in the gathered imagery of the event. For example, the facial identification module 118 may analyze features of the baseline imagery to learn about various characteristics of a participant's face so as to facilitate identification of the participant in other imagery.

Not all embodiments of the systems and methods described herein consider or otherwise rely on the aforementioned baseline imagery. Similarly, not all embodiments of the systems and methods herein need to know the association between a participant and their identifier prior to the event. Rather, the system 100 can learn to recognize participants in event imagery by, for example, their facial characteristics and/or their identifier.

For example, in some embodiments, a user 106 such as an event organizer may not be provided with a list of participants before the event. In this case, the OCR engine 138 (discussed below) may analyze received imagery to generate a candidate list of participants.

The processor 108 may receive event imagery from the user 106 as well as one or more imagery gatherers 128, 130, 132, and 134 (for simplicity, “gatherers”) over one or more networks 136. The gatherers 128-34 are illustrated as devices such as laptops, smartphones, cameras, smartwatches and PCs, or any other type of device configured or otherwise in operable communication with an imagery gathering device (e.g., a camera) to gather imagery of an event. With respect to the camera 132, imagery may be gathered by an operator of the camera and stored on an SD card. Later, imagery stored on the SD card may be provided to the processor 108 for analysis.

The gatherers 128-34 may include people such as event spectators. For example, these spectators may be friends of event participants, family members of participants, fans of participants, or otherwise people interested in watching and gathering imagery of the event. In some embodiments, a gatherer 128 may be a professional photographer or videographer hired by the event organizer.

The gatherers 128-34 may configure their respective imagery gathering devices so that, upon gathering imagery (e.g., taking a picture), the gathered imagery is automatically uploaded to the processor 108. Or, the gatherers 128-34 may review their gathered imagery before communicating their imagery to the processor 108 for analysis.

When the user 106 creates a project for an event, they may communicate an invitation to the gatherers 128-34 via any suitable method. For example, the user 106 may send an invite over email, SMS, through social media, through text, or the like. The message may include a link that, when activated, allows the gatherer 128-34 to upload their imagery to the processor 108.

The network(s) 136 may link these various assets and components with various types of network connections. The network(s) 136 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network(s) 136 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The database(s) 126 may store imagery and other data related to, for example, certain people (e.g., their facial features), places, data associated with events, or the like. In other words, the database(s) 126 may store data regarding specific people or other entities such that the various of modules of the processor 108 can recognize these people or entities in received imagery. The exact type of data stored in the database(s) 126 may vary as long as the features of various embodiments described herein may be accomplished. For example, in some embodiments, the database(s) 126 may store data regarding an event such as a path and/or timing of a race.

The processor interface 112 may receive imagery from the user device 102 (e.g., a camera of the user device 102) in a variety of formats. The imagery may be sent via any suitable protocol or application such as, but not limited to, email, SMS text message, iMessage, Whatsapp, Facebook, Instagram, Snapchat, other social media platforms or messaging applications, etc. Similarly, the interface 112 may receive event imagery from the gatherers 128-34.

The processor 108 may then execute any one or more of a variety of procedures to analyze the received imagery. For example, the indicia identification module 116 may execute one or more of an OCR (optical character recognition) engine 138 and a bar code reader 140. The OCR engine 138 may implement any suitable technique to analyze the identifier(s) in the received imagery. In some embodiments, the OCR engine 138 may execute matrix matching procedures in which portions of the received imagery (e.g., those corresponding to an identifier) are compared to a glyph based on pixels.

In other embodiments, the OCR engine 138 may execute feature extraction techniques in which glyphs are decomposed into features based on lines, line directions, loops, or the like, to recognize components of the identifier(s). The OCR engine 138 may also perform any type of pre-processing steps such as normalizing the aspect ratio of received imagery, de-skewing the received imagery, despeckling the received imagery, or the like.

The bar code reader 140 may scan imagery for any type of visual or symbolic indicia. These may include, but are not limited to, bar codes or quick response (QR) codes that may be present on a participant's bib or the like.

Some embodiments may use, either as a replacement or as an augmentation, identifiers other than bibs. These may include but are not limited to QR codes as discussed above; geometric patterns; or color patterns on the participant's body, headbands, wristbands, arm bands, or leg bands. These identifiers may uniquely identify the participant and therefore reduce the chance of confusion.

In one exemplary scenario, a participant may wear a headband with a number like 2345, where the numbers are added and the last digit is used to derive the color of the headband −2+3+4+5=14. The last digit is 4, and 4 gets mapped to Yellow. If the indicia identification module 116 fails to detect the leading 2, but only sees “345” and the color yellow, then it knows the missing digit has to be a 2 for the sum of the digits to end in 4.

The facial identification module 118 may execute a variety of facial detection programs to detect the presence of faces in various imagery portions. The programs may include or be based on OPENCV and, specifically, neural networks, for example. Again, these programs may execute on the user device 102, and devices associated with the gatherers 128-34, and/or on a server at a remote location. The exact techniques or programs may vary as long as they can detect facial features in imagery to accomplish the features of various embodiments described herein.

The facial identification module 118 may execute a variety of facial recognition programs to identify certain people in various imagery portions. The facial identification module 118 may be in communication with one or more databases 126 that store data regarding people and their facial characteristics, such as baseline imagery as discussed above. The facial identification module 118 may use geometric-based approaches and/or photometric-based approaches, and may use techniques based on principal component analysis, linear discriminant analysis, neural networks, elastic bunch graph matching, HMM, multilinear subspace learning, or the like.

The facial identification module 118 may detect face attributes through facial embedding. Face attributes detected may include, but are not limited to, Hasglasses, Hassmile, age, gender, and face coordinates for: pupilLeft, pupilRight, noseTip, mouthLeft, mouthRight, eyebrowLeftOuter, eyebrowLeftInner, eyeLeftOuter, eyeLeftTop, eyeLeftBottom, eyeLeftInner, eyebrowRightInner, eyebrowRightOuter, EyeRightInner, eyeRightTop eyeRightBottom, eyeRightOuter, noseRootLeft, noseRootRight, noseLeftAlarTop, noseRightAlarTop, noseLeftAlarOutTip, noseRightAlarOutTip, upperLipTop, upperLipBottom, underLipTop, underLipBottom, or the like.

The facial identification module 118 may implement a variety of vision techniques to analyze the content of the received imagery. These techniques may include, but are not limited to, scale-invariant feature transform (SIFT), speeded up robust feature (SURF) techniques, or the like. These may include supervised machine learning techniques as well as unsupervised machine learning techniques. The exact techniques used may vary as long as they can analyze the content of the received imagery to accomplish the features of various embodiments described herein.

The facial identification module 118 may group select imagery portions as being part of imagery associated with one or more people. That is, an imagery portion may be one of many identified as including a certain person. These imagery portions may be indexed and stored for later retrieval and viewing.

The time analysis module 120 may receive data regarding the timing of imagery. Specifically, data regarding when the imagery was gathered may be used to help identify participants in the gathered imagery. For example, data regarding when and where the imagery was taken, and whether the user was near the photographer at that time and place, can further enhance identification rates by reducing the set of possible participants in the imagery to be identified using, e.g., facial recognition. This may occur when participants are wearing electronic tags that place them at a certain location at a certain time wherein a photographer is at the same location (and the imagery includes time data). With this data, the processor 108 can increase the confidence that a participant is in imagery taken at a specific time, and similarly reduce the confidence, or even rule out, imagery taken at other times.

The location module 122 may leverage data regarding the location of the imagery gathering device when gathering imagery as well as data regarding the location of participants. Embodiments of the systems and methods described herein can use multiple means to identify the location of a participant in time and space. These include, but are not limited to RFID, NFC, Bluetooth, Wifi, GPS or other techniques or devices worn by the participant(s) that detect or otherwise interact with a sensor or beacon in proximity to an imagery gathering device. In some embodiments, these sensors or beacons may be placed at various locations throughout the path of the race. Additionally or alternatively, these sensors may simply record the locations and positions of participants at certain time intervals.

In some embodiments, the gathered imagery may be tagged with its capture time and its location. The imagery's location may either be implicit (e.g., if the photographer is assigned a specific location), or determined via the camera/cellphone location information. This information is typically gathered by, for example, GPS, Wifi, cell tower and other geo-location technologies.

Accordingly, this time and location data may be analyzed by the time analysis module 120 and the location module 122, respectively, to help identify whether a certain participant is present in received imagery.

Based on the analysis conducted by one or more of the modules 116-22, the imagery selection module 124 may then select imagery portions that include one or more selected participants. The imagery selection module 124 may have higher confidence that a participant is in some imagery portions than other imagery portions.

In some embodiments, one or more of the modules 116-22 may provide a “vote” that a participant is in a certain imagery portion. For example, the facial identification module 118 may determine that a participant is in a received imagery portion. However, the imagery portion may have occlusions such that the participant's identifier is not completely shown in the imagery portion. In this case, the facial identification module 118 may output a vote that the participant is in the imagery portion, but the indicia identification module 116 would output a vote that the imagery portion does not include the participant since the indicia identification module 116 did not identify the participant's associated identifier. However, if the location module 122 received location data suggesting that the participant was at the location of the imagery gathering device at the time the imagery was gathered, the location module 122 may output a vote that the participant is in the imagery and thereby break the tie between the other two modules 116, 118.

In some embodiments, the imagery selection module 124 may require a certain number of “votes” that a participant is in the imagery before determining the imagery portion includes the participant. For example, in the scenario above, the outputs from the facial identification module 118 and the location module 122 may be sufficient for the imagery selection module 124 to determine that the participant is in the received imagery portion. Other, less sensitive applications may require only one of the modules 116-22 to determine that a participant is in a certain imagery portion before concluding the imagery portion includes the participant.

These “votes” may essentially represent a confidence level that an imagery portion includes a certain participant. This confidence level may depend on several factors, in addition to the analyses performed by the modules 116-22 discussed above. For example, if the database(s) 126 include baseline imagery of a participant, and a participant in received imagery matches a participant in baseline imagery, the systems and methods described herein may have high confidence (e.g., above some predetermined threshold) that the participant is present in the received imagery.

The above-discussion regarding votes is only meant to provide a simplified embodiment of how imagery may be selected. In other embodiments, these votes may be merged in accordance with novel algorithms reliant on various machine learning procedures such as random forests or others. Accordingly, the present application is not to be limited to any particular procedures for aggregating these votes.

As another example, if a participant's bib is occluded by another participant or other object, their identifier may not be entirely shown. In this case, if no other data is considered, the systems and methods described herein may have low confidence that a certain participant is in the received imagery.

Similarly, even if the systems and methods have less confidence regarding the bib identifier recognition, or did not recognize (or even see) some digits of the identifier, but also has medium confidence in a face match, then the systems and methods can conclude that a participant is likely in the present imagery. In other words, certain information (or lack thereof) may be supplemented by other types of identifying information to identify a participant.

Accordingly, there are a number of factors that can affect the confidence value or score assigned to individual imagery portions. Imagery portions that have confidence value or score above a threshold may be selected. In some embodiments, a user 106 may be presented with a plurality of imagery portions with the highest confidence scores first. The user 106 may also be presented with the option to view other imagery portions with lower confidence scores as well.

The imagery selection module 124 may also implement a positive/negative face aesthetics neural network to select the best imagery portions. For example, a neural network may select imagery portions of a participant with their eyes open over imagery portions of the participant with their eyes closed. There may be a plurality of imagery aesthetics that may be considered. The imagery analysis may detect which photos are blurry and which are focused, which are centered appropriately, etc.

Imagery portions determined to include a certain participant may be selected and presented to the user 106. The user may then provide feedback regarding whether the imagery portion(s) actually include the participant of interest. This feedback may help refine or otherwise improve the analyses performed by the processor(s) 108.

Additionally, the processor(s) 108 may generate statistics based on data regarding the received imagery. As discussed above, timing data regarding gathered imagery may be combined with data regarding indicia recognition. This combination of data may be used to generate statistics (e.g., mean, standard deviation) on, for example, the delay between when imagery is taken by a stationary imagery gathering device and the progress of the participant wearing the identified indicia.

For example, a race may have multiple, stationary imagery gathering devices positioned at various locations along the race path. If the processor 108 determines that these imagery gathering devices are taking photographs on average 3 seconds before a certain participant is at their location along the race path, the processor 108 may instruct the imagery gathering devices to delay taking photographs by a few seconds to ensure that they gather imagery of a certain participant.

Knowledge of the race path may also assist in generating confidence values and in selecting imagery portions. For example, in some events, a race path may have a series of different obstacles. Timing data may show that a certain participant is at a second obstacle in the race at time t₂. If an imagery portion appears to show the participant at the first obstacle in the race (which occurs before the second obstacle) at time t>t₂, then the systems and methods described herein would know that it could not be this participant, as the participant should be at the first obstacle before they are at the second obstacle.

These generated statistics may factor into the confidence value of an imagery portion. For example, an imagery portion may appear to include a certain participant, and the imagery portion was gathered where the participant was expected to be at that time. This imagery portion would therefore have a higher confidence score than another imagery portion taken long before or after the participant's timing data (e.g., as measured by mean or standard deviation values).

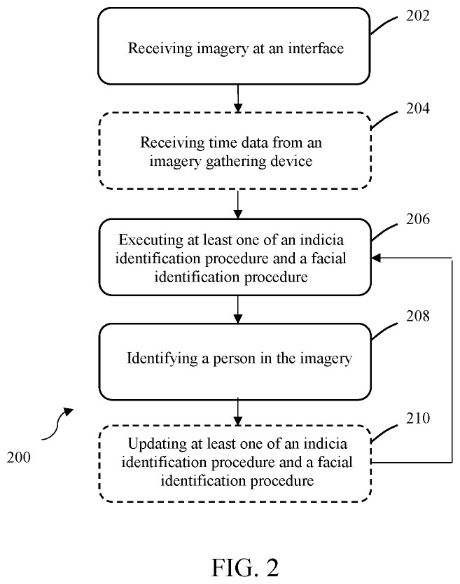

FIG. 2 depicts a flowchart of a method 200 for identifying at least one participant in imagery related to an event in accordance with one embodiment. The system 100 of FIG. 1, or components thereof, may perform the steps of method 200.

Step 202 involves receiving imagery at an interface. The imagery may include several different types of imagery such as those discussed previously. The imagery may be received by several gatherers as discussed previously, and may contain videos and photos taken using smartphones or, e.g., DSLR cameras or any other device. This pool of imagery can also include photos contributed by professional photographers hired by an event organizer, for example.

Optional step 204 involves receiving time data regarding when the imagery was gathered. For example, the received imagery may include metadata that indicates when the imagery was gathered (e.g., at what time).

Step 206 involves executing, using a processor executing instructions stored on memory, at least one of an indicia identification procedure to identify at least one visual indicia in the imagery and a facial identification procedure to identify at least one face in the imagery.

The indicia identification procedure and the facial identification procedure may be performed by the indicia identification module 116 and the facial identification module 118, respectively, of FIG. 1. Accordingly, step 206 may involve executing one or more computer vision or machine learning techniques to analyze received imagery to learn about the content of said imagery. Specifically, step 206 may help learn about which (if any) participants are in the received imagery portions.

Step 208 involves identifying, using the processor, a person in the imagery based on at least one of the execution of the indicia identification procedure and the facial identification procedure. Step 208 may involve considering output from the indicia identification module 116, the facial identification module 118, or both.

Step 210 involves receiving feedback regarding the person identified in the imagery, and updating at least one of the indicia identification procedure and the facial identification procedure based on the received feedback. For example, a user such as the user 106 may be presented with a plurality of imagery portions believed to include a certain participant. The user may then confirm whether the participant is actually in the imagery portions. Similarly, the user may indicate who is actually in the analyzed imagery. This feedback may be used to improve or otherwise refine the imagery analyses.

The imagery analyses discussed above may be conducted over all imagery portions received regarding an event. Accordingly, the method 200 of FIG. 2 may be used to identify all imagery portions that include a certain participant. Imagery portions determined to include a certain participant may then be returned to a user (such as the participants themselves).

The method 200 of FIG. 2 is merely exemplary, and the features disclosed herein may be performed in a variety of ways and in accordance with a various strategies. For example, some of the disclosed logic may be performed at the imagery portion level (i.e., the analysis of individual pieces of imagery). Then, the systems and methods described herein may perform a more holistic review of the imagery portions. For example, this may involve grouping or clustering faces of the same participant together. From this clustering, the systems and methods may be able to compute “distances” between detected faces and calculate confidence values therefrom. Other examples of these steps may include identifying possible indicia if not initially supplied as discussed previously, computing statistics regarding imagery as discussed previously, and creating an ordered list of all imagery portions that may include a certain participant, wherein the list ranks the imagery portions by confidence.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for identifying at least one participant in imagery related to an event, the method comprising:
receiving imagery related to the event;
executing, using a processor executing instructions stored on memory, at least one of:
an indicia identification procedure to identify at least one visual indicia in the imagery, and
a facial identification procedure to identify at least one face in the imagery; and
identifying, using the processor, a person in the imagery based on at least one of the execution of the indicia identification procedure and the facial identification procedure.

2. The method of claim 1 further comprising:
receiving time data from an imagery gathering device regarding when imagery was gathered,
receiving time data regarding when an indicia was recognized, and
calibrating the processor based on a difference between the time data from an imagery gathering device and the time data regarding when an indicia was recognized.

3. The method of claim 1 further comprising executing a location procedure to determine where the received imagery was gathered, wherein identifying the person in the imagery further comprises utilizing where the received imagery was gathered.

4. The method of claim 3 wherein the location procedure analyzes at least one of location data associated with an imagery gathering device and location data associated with the person in the imagery.

5. The method of claim 1 further comprising executing, using the processor, a clothing recognition procedure to identify clothing in the imagery, wherein identifying the person in the imagery further comprises utilizing the identified clothing.

6. The method of claim 1 further comprising:
receiving feedback regarding the person identified in the imagery; and
updating at least one of the indicia identification procedure and the facial identification procedure based on the received feedback.

7. The method of claim 1 wherein the visual indicia include at least a portion of an identifier worn by a person in the imagery.

8. The method of claim 1 further comprising receiving time data regarding when the imagery was gathered, wherein identifying the person in the imagery further comprises matching the received time data related to the imagery with at least one of time data regarding the participant.

9. The method of claim 1 further comprising:
assigning a confidence score to an imagery portion based on at least one of the execution of the indicia identification procedure and the facial recognition procedure; and
determining whether the assigned confidence score exceeds a threshold, wherein identifying the person in the imagery comprises identifying the person based on the assigned confidence score of the imagery portion exceeding the threshold.

10. The method of claim 1 further comprising indexing a plurality of imagery portions of the imagery that include an identified person for later retrieval.

11. The method of claim 1 further comprising:
receiving a baseline imagery of a first participant,
receiving a first identifier, and
associating the first identifier with the first participant based on the baseline imagery of the first participant.

12. A system for identifying at least one participant in imagery related to an event, the system comprising:
an interface for receiving imagery related to an event; and
a processor executing instructions stored on memory and configured to:
execute at least one of:
an indicia identification procedure to identify at least one visual indicia in the imagery, and
a facial identification procedure to identify a face in the imagery; and
identify a person in the imagery based on the execution of at least one of the indicia identification procedure and the facial identification procedure.

13. The system of claim 12 wherein the processor is further configured to execute a location procedure to determine where the received imagery was gathered, and identify the person in the imagery utilizing where the imagery was gathered.

14. The system of claim 13 wherein the location procedure analyzes at least one of location data associated with an imagery gathering device and location data associated with the person in the imagery.

15. The system of claim 12 wherein the processor is further configured to execute a clothing recognition procedure to identify clothing in the imagery, and identify the person in the imagery utilizing the identified clothing.

16. The system of claim 12 wherein the interface is further configured to receive feedback regarding the person identified in the imagery, and the processor is further configured to update at least one of the indicia identification procedure and the facial identification procedure based on the received feedback.

17. The system of claim 12 wherein the visual indicia includes at least a portion of an identifier worn by a person in the imagery.

18. The system of claim 12 wherein the processor is further configured to receive time data related to the imagery, and identify the person utilizing the received time data related to the imagery.

19. The system of claim 12 wherein the processor is further configured to:
assign a confidence score to an imagery portion based on at least one of the execution of the indicia identification procedure and the facial recognition procedure, and
determine whether the assigned confidence score exceeds a threshold, and
identify the person in the imagery portion based on the assigned confidence score exceeding the threshold.

20. The system of claim 12 wherein the processor is further configured to index a plurality of imagery portions of the imagery that include an identified person for later retrieval.
